(19) United States
(12) Patent Application Publication
(10) Pub. No.: US 2019/0205817 A1
(43) Pub. Date: Jul. 4, 2019

(54) DELIVERY SYSTEM, INFORMATION PROCESSING DEVICE, INFORMATION PROCESSING METHOD, AND RECORDING MEDIUM

(71) Applicant: TOYOTA JIDOSHA KABUSHIKI KAISHA, Toyota-shi (JP)

(72) Inventors: Shin SAKURADA, Toyota-shi (JP); Koichi Ando, Nagoya-shi (JP); Mutsumi Matsuura, Okazaki-shi (JP); Masato Endo, Nagakute-shi (JP); Koki Fujita, Suginami-ku (JP)

(73) Assignee: TOYOTA JIDOSHA KABUSHIKI KAISHA, Toyota-shi (JP)

(21) Appl. No.: 16/196,018

(22) Filed: Nov. 20, 2018

(30) Foreign Application Priority Data
Dec. 28, 2017 (JP) 2017-255027

(51) Int. Cl. G06Q 10/08; G01S 5/00; G07C 5/00; G06Q 30/02; G07C 9/00; B60R 25/24

(52) U.S. Cl. CPC G06Q 10/083; G01S 5/0027; B60R 25/241; G06Q 30/0281; G07C 9/00896; G07C 5/008

(57) ABSTRACT

A delivery system includes: a first acquisition unit configured to acquire first information at a first timing; a first determination unit configured to determine whether delivery of luggage by a deliverer is possible based on the first information; a second acquisition unit configured to acquire second information on position information of the designated vehicle at a second timing; a second determination unit configured to determine whether delivery of the luggage by the deliverer is possible based on the second information; a first notification unit configured to notify a receiver of predetermined first notification information when it is determined that delivery of the luggage to the designated vehicle is not possible; and an authentication information issuing unit configured to issue authentication information for locking and unlocking a predetermined area of a designated vehicle to a terminal of the deliverer.

### INCORPORATION BY REFERENCE

The disclosure of Japanese Patent Application No. 2017-255027 filed on Dec. 28, 2017 including the specification, drawings and abstract is incorporated herein by reference in its entirety.

### BACKGROUND

### 1. Technical Field

The disclosure relates to a delivery system, an information processing device, an information processing method, and a recording medium.

### 2. Description of Related Art

Japanese Unexamined Patent Application Publication No. 2006-206225 (JP 2006-206225 A) discloses a technique for allowing a receiver to register a luggage-receiving vehicle at which the receiver will receive a delivery object and enabling the receiver to receive the delivery object even when the receiver is absent by the delivery object being accommodated in a trunk of the registered luggage-receiving vehicle.

### SUMMARY

In such a delivery system according to the related art (for example, see JP 2006-206225 A), a user can designate a cargo compartment of a vehicle, for example, when the user orders a product and designates a delivery destination using the Internet or the like. At this time, it may be difficult to deliver luggage to the cargo compartment of the designated vehicle depending on a parking position of the vehicle. Accordingly, in this case, a predetermined warning is given to the user.

In such a delivery system, it is conceivable that luggage can be delivered to a cargo compartment of a vehicle. However, a vehicle is mainly used as moving means. Accordingly, even if a parking position of a vehicle is set to a parking position at which luggage can be delivered to a cargo compartment of the vehicle when the cargo compartment of the vehicle is designated as a delivery destination by a user, there is a likelihood that the vehicle will have moved away from the parking position when luggage is actually delivered to the cargo compartment of the vehicle thereafter. In this case, there is likelihood that luggage may not be delivered to the cargo compartment of the vehicle. In this way, there is room for improvement in the techniques for delivering luggage to a cargo compartment of a vehicle.

The disclosure is for minimizing a likelihood that luggage will not be delivered to a predetermined area of a vehicle in a system in which a predetermined area of a vehicle is used as a delivery place of luggage.

A delivery system according to a first aspect of the disclosure is a system in which a predetermined area of a vehicle is used as a delivery place of luggage. The delivery system includes: a first acquisition unit configured to acquire first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage; a first determination unit configured to determine, based on the first information acquired by the first acquisition unit at the first timing, whether delivery of the luggage, by the deliverer, to the designated vehicle parked at the scheduled parking position when the deliverer delivers the luggage is possible; and an authentication information issuing unit configured to issue authentication information for locking and unlocking the predetermined area of the designated vehicle to a terminal of the deliverer.

According to the above aspect, at the first timing, it is determined whether delivery of the luggage to the designated vehicle is possible based on the first information. Here, the first timing is, for example, a time at which a predetermined area of a vehicle has been designated as a delivery destination of luggage by a user who uses the delivery system. The predetermined area of a vehicle is, for example, a cargo compartment of a vehicle. The predetermined area of a vehicle is not limited thereto and may be a passenger compartment of the vehicle. Here, the user can designate a designated vehicle serving as a delivery destination of luggage and can also designate a scheduled parking position of the designated vehicle. Then, the first acquisition unit acquires the scheduled parking position of the designated vehicle as the first information. The first acquisition unit acquires parking lot information of the scheduled parking position (a parking lot type such as a surface type or a mechanical type, a size of a parking space, whether an authority is required for entering the parking lot, or the like) along with the scheduled parking position of the designated vehicle as the first information. The parking lot information is registered in advance in the delivery system, for example, in correlation with the scheduled parking position.

The first determination unit determines whether delivery of the luggage to the designated vehicle is possible based on the first information, and the delivery system can set deliverable conditions (for example, based on the techniques described in the documents according to the related art) when it is determined that delivery of the luggage to the designated vehicle is not possible. In this case, for example, the delivery system may prompt the user to change the scheduled parking position to a place in which luggage can be delivered to the predetermined area of the vehicle. Accordingly, it is possible to deliver the luggage to the designated vehicle at the scheduled parking position.

Here, when the designated vehicle moves away from the scheduled parking position at the time of actual delivery of the luggage to the designated vehicle, there is likelihood that the luggage may not be delivered to the designated vehicle. Specifically, at the time of actual delivery of the luggage to the designated vehicle, the luggage cannot be delivered to the designated vehicle, for example, when, the designated vehicle has moved away from the scheduled parking position and then the designated vehicle is parked in a mechanical type parking lot, in a parking lot requiring an authority for entering the parking lot, or in a place in which a space for delivering the luggage is not secured around the designated vehicle.

The delivery system according the first aspect of the disclosure further includes a second acquisition unit configured to acquire, at a second timing, second information on position information of the designated vehicle, and the second timing being a predetermined timing after the first timing and before the luggage is delivered to the receiver; a second determination unit configured to determine, based on the second information acquired by the second acquisition unit at the second timing, whether delivery of the luggage, by the deliverer, to the designated vehicle at a position indicated by the second information is possible; and a first notification unit configured to transmit predetermined first notification information to the receiver when the second determination unit determines that delivery of the luggage to the designated vehicle is not possible

According to the above aspect, it is determined whether delivery of the luggage to the designated vehicle is possible based on the second information at the second timing. Here, the second timing is a predetermined timing after the first timing and before a scheduled delivery time, for example, a time close to the scheduled delivery time. According to the above aspect, when the position based on the second information is the same as the scheduled parking position, the second determination unit determines that delivery of the luggage to the designated vehicle is possible. The second information is, for example, current position information of the designated vehicle at the second timing as will be described later.

On the other hand, when the position based on the second information is different from the scheduled parking position, the second determination unit determines whether delivery of the luggage to the designated vehicle at a position based on the second information other than the scheduled parking position is possible. At this time, the second determination unit can perform the determination based on parking lot information at the position other than the scheduled parking position. The disclosure is not limited thereto, and the second determination unit may determine that delivery of the luggage to the designated vehicle is not possible when the position based on the second information is different from the scheduled parking position.

When it is determined that delivery of the luggage to the designated vehicle is not possible, the receiver is notified of the predetermined first notification information. The predetermined first notification information is, for example, information indicating that delivery of the luggage to the designated vehicle is not possible. Then, the receiver who has been informed of the first notification information moves the designated vehicle, for example, to a place in which delivery of luggage to a predetermined area of a vehicle is possible. Alternatively, a re-delivery request with a delivery date and time or a delivery place designated again is issued. In this way, when the designated vehicle is in a state in which delivery of luggage to a predetermined area of the vehicle is possible, the deliverer can deliver the luggage to the predetermined area of the designated vehicle using authentication information for locking and unlocking the predetermined area of the designated vehicle, which is issued to a terminal of the deliverer.

According to the above aspect, it is possible to minimize a likelihood that luggage will not be delivered to a predetermined area of a vehicle in a system in which a predetermined area of a vehicle is used as a delivery place of luggage.

In the above aspect, the delivery system may further include a third acquisition unit configured to acquire third information which is predetermined information on a parking lot. The second acquisition unit may be configured to acquire, as the second information, current position information which is information related to a position of the designated vehicle at a time of the luggage to be delivered. The second determination unit may be configured to determine whether delivery of the luggage to the designated vehicle is possible based on the current position information acquired by the second acquisition unit and the third information acquired by the third acquisition unit.

According to the above aspect, the third acquisition unit acquires third information including information such as a position of a parking lot, a parking lot type, a size of a parking space, and whether an authority is required for entering the parking lot, for example, for each parking lot included in predetermined map information. The second determination unit compares the current position information with position information of parking lots included in the predetermined map information, and specifies a parking lot corresponding to the current position information. Then, the second determination unit determines whether delivery of the luggage to the designated vehicle is possible based on the third information. Accordingly, even when the designated vehicle moves away from the scheduled parking position, it is possible to deliver the luggage.

In the above aspect, the second acquisition unit may be configured to acquire the current position information as the second information when the designated vehicle is in a parked state.

When it is estimated that the designated vehicle is moving based on the current position information, the designated vehicle moves after the current position information has been acquired at the second timing. However, according to the above aspect, it is possible to easily specify a parking lot corresponding to the current position information and thus to deliver the luggage.

In the above aspect, the parked state may be a state in which at least one of condition (i), condition (ii), condition (iii), and condition (iv) is satisfied. The condition (i) may be a condition that a system power supply of the designated vehicle is turned off. The condition (ii) may be a condition that an engine of the designated vehicle is turned off. The condition (iii) may be a condition that a parking brake of the designated vehicle is turned on. The condition (iv) may be a condition that the designated vehicle has been stopped for a predetermined time or more.

In the above aspect, the delivery system may further include a third acquisition unit configured to acquire third information which is predetermined information on a parking lot. The second acquisition unit may be configured to acquire, as the second information, movement position information which is position information of the designated vehicle based on a movement schedule of the designated vehicle. The second determination unit may be configured to determine whether delivery of the luggage to the designated vehicle is possible based on the movement position information acquired by the second acquisition unit and the third information acquired by the third acquisition unit. According to the above aspect, even when the designated vehicle moves away from the scheduled parking position, it is possible to deliver the luggage.

In the above aspect, the delivery system may further include a second notification unit configured to transmit predetermined second notification information to the receiver when both of conditions (v) and (vi) are satisfied. The condition (v) may be a condition that a position of the designated vehicle based on the second information acquired by the second acquisition unit is different from the scheduled parking position, and condition (vi) may be a condition that the second determination unit determines that delivery of the luggage to the designated vehicle is possible. The predetermined second notification information may be, for example, information indicating that delivery of the luggage to the designated vehicle at a position based on the second information is possible.

According to the above aspect, the receiver who has been notified of the second notification information can ascertain that the luggage will be delivered to the predetermined area of the designated vehicle even when the designated vehicle is away from the scheduled parking position at the first timing. Accordingly, it is possible to enhance convenience for a user who uses the delivery system.

In the above aspect, the designated vehicle may be a vehicle which is owned by the receiver, or the designated vehicle may be a vehicle which is owned by a third party other than the receiver. According to the above aspect, the receiver can set a vehicle serving as a delivery destination of the luggage (a designated vehicle) from a plurality of vehicles. Accordingly, it is possible to enhance convenience for a user who uses the delivery system. The third party is a user who is registered as a user in the delivery system.

In the above aspect, the delivery system may further include a change receiving unit configured to receive change of the designated vehicle when the second determination unit determines that delivery of the luggage to the designated vehicle is not possible. According to the above aspect, it is possible to minimize a likelihood that luggage will not be delivered to a predetermined area of a vehicle.

In the above aspect, the second determination unit may be configured to determine whether the delivery of luggage, by the deliverer, to the designated vehicle at the position indicated by the second information is possible when the first determination unit determines that the delivery of the luggage, by the deliverer, to the designated vehicle parked at the scheduled parking position when the deliverer delivers the luggage is possible.

In the above aspect, the authentication information issuing unit may be configured to issue the authentication information to the terminal of the deliverer when the second determination unit determines that the delivery of luggage, by the deliverer, to the designated vehicle at the position indicated by the second information is possible.

An information processing device according to a second aspect of the disclosure is a device that controls a system in which a predetermined area of a vehicle is used as a delivery place of luggage. The information processing device includes: a first acquisition unit configured to acquire first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage; a first determination unit configured to determine, based on the first information acquired by the first acquisition unit at the first timing, whether delivery of the luggage, by the deliverer, to the designated vehicle parked at the scheduled parking position when the deliverer delivers the luggage is possible; a second acquisition unit configured to acquire, at a second timing, second information on position information of the designated vehicle, and the second timing being a predetermined timing after the first timing and before the luggage is delivered to the receiver; a second determination unit configured to determine, based on the second information acquired by the second acquisition unit at the second timing, whether delivery of the luggage, by the deliverer, to the designated vehicle at a position indicated by the second information is possible; a first notification unit configured to transmit predetermined first notification information to the receiver when the second determination unit determines that delivery of the luggage to the designated vehicle is not possible; and an authentication information issuing unit configured to issue authentication information for locking and unlocking the predetermined area of the designated vehicle to a terminal of the deliverer.

An information processing method according to a third aspect of the disclosure is a method of controlling a system in which a predetermined area of a vehicle is used as a delivery place of luggage. The information processing method includes:

causing a computer to acquire first information at a first timing, the first timing being a predetermined timing before the luggage is delivered to a receiver, the first information being information a scheduled parking position of a designated vehicle when the luggage is delivered by a deliverer, and the designated vehicle being a delivery destination of the luggage; causing the computer to determine, based on the first information acquired at the first timing, whether delivery of the luggage, by the deliverer, to the designated vehicle parked at the scheduled parking position when the deliverer delivers the luggage is possible; causing the computer to acquire, at a second timing, second information on position information of the designated vehicle, and the second timing being a predetermined timing after the first timing and before the luggage is delivered to the receiver; causing the computer to determine, based on the second information acquired at the second timing, whether delivery of the luggage, by the deliverer, to the designated vehicle at a position indicated by the second information is possible; causing the computer to transmit predetermined first notification information to the receiver when the computer determines that delivery of the luggage to the designated vehicle is not possible; and causing the computer to issue authentication information for locking and unlocking the predetermined area of the designated vehicle to a terminal of the deliverer.

A non-transitory recording medium according to a fourth aspect of the disclosure is a non-transitory recording medium storing a program for controlling a system in which a predetermined area of a vehicle is used as a delivery place of luggage. The program causes a computer to perform acquiring first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage; determining, based on the first information acquired at the first timing, whether delivery of the luggage, by the deliverer, to the designated vehicle parked at the scheduled parking position when the deliverer delivers the luggage is possible; acquiring, at a second timing, second information on position information of the designated vehicle, and the second timing being a predetermined timing after the first timing and before the luggage is delivered to the receiver; determining, based on the second information acquired at the second timing, whether delivery of the luggage, by the deliverer, to the designated vehicle at a position indicated by the second information is possible; transmitting predetermined first notification information to the receiver when the computer determines that delivery of the luggage to the designated vehicle is not possible; and issuing authentication information for locking and unlocking the predetermined area of the designated vehicle to a terminal of the deliverer.

According to the above-mentioned configurations, it is possible to minimize a likelihood that luggage will not be delivered to a predetermined area of a vehicle in a system in which a predetermined area of a vehicle is used as a delivery place of luggage.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a delivery system according to an embodiment;

FIG. 2 is a diagram illustrating hardware configurations of an onboard unit, a deliverer user terminals, a central server, and a delivery management server;

FIG. 3 is a diagram illustrating a functional configuration of the delivery management server;

FIG. 4 is a diagram illustrating an example of a first information table;

FIG. 5 is a diagram illustrating an example of a second information table;

FIG. 6 is a diagram illustrating an example of a third information table;

FIG. 7 is a diagram illustrating a functional configuration of the central server;

FIG. 8 is a diagram illustrating a functional configuration of a deliverer user terminal;

FIG. 9 is a diagram illustrating an authentication processing screen;

FIG. 10 is a diagram illustrating a flow of operations in a trunk-sharing system according to a first embodiment; and

FIG. 11 is a diagram illustrating a flow of operations in a trunk-sharing system according to a third embodiment.

### DETAILED DESCRIPTION OF EMBODIMENTS

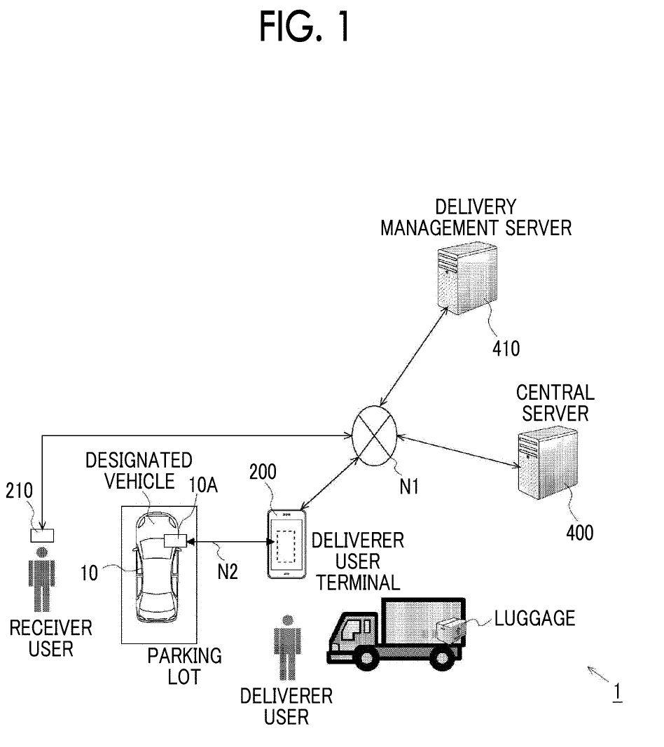

FIG. 1 is a diagram schematically illustrating a configuration of a delivery system according to an embodiment. The delivery system 1 is a system in which a cargo compartment (a trunk) of a vehicle is commonly used (shared) as a delivery place of luggage while luggage is being delivered to a predetermined delivery destination. Here, a vehicle that serves as a delivery destination of luggage is referred to as a designated vehicle 10.

In the example illustrated in FIG. 1, the delivery system 1 includes a designated vehicle 10, an onboard unit 10A that is installed in the designated vehicle 10, a deliverer user terminal 200, a receiver user terminal 210, a central server 400, and a delivery management server 410. The onboard unit 10A, the deliverer user terminal 200, the receiver user terminal 210, the central server 400, and the delivery management server 410 are connected to each other via a network N1. The onboard unit 10A is connected to the deliverer user terminal 200 via a network N2 including a short-range radio communication network.

In this embodiment, a user (a receiver) who requests delivery of luggage using the delivery system 1 designates a cargo compartment of a vehicle owned by the user as a delivery destination at the time of designating a delivery destination using a receiver user terminal 210. Here, the receiver user terminal 210 is, for example, a mobile terminal (such as a smartphone or a tablet terminal) carried by a receiver or a computer having a general configuration.

The delivery management server 410 acquires first information on a scheduled parking position of the designated vehicle 10 at the time of delivery of luggage by a deliverer at a first timing. In this embodiment, the first timing is a timing at which a receiver designates a delivery destination using the receiver user terminal 210. However, the first timing is not limited to the timing at which the receiver designates the delivery destination if the first timing is before performing the delivery of luggage. For example, the first timing may be a timing a predetermined time after the receiver designates the delivery destination. Then, the delivery management server 410 determines whether delivery of luggage to the designated vehicle 10 parked at the scheduled parking position is possible at the time of delivery of luggage by a deliverer based on the first information. Through this determination, it is assumed that a deliverer will be able to deliver luggage to a cargo compartment of the designated vehicle 10. However, when the designated vehicle 10 has moved away from the scheduled parking position at the time of actual delivery of luggage to the designated vehicle 10, there is concern that luggage may not be delivered to the designated vehicle 10. Specifically, at the time of actual delivery of the luggage to the designated vehicle 10, the luggage cannot be delivered to the designated vehicle 10, for example, when the designated vehicle 10 has moved away from the scheduled parking position and thus the designated vehicle 10 is parked in a mechanical type parking lot, in a parking lot requiring an authority for entering the parking lot, or in a place in which a space for delivering the luggage is not secured around the designated vehicle 10.

Therefore, the delivery management server 410 acquires second information on position information of the designated vehicle 10 at a predetermined timing (hereinafter referred to as a second timing) after the first timing and before a scheduled delivery time. Here, the second timing is, for example, a time close to the scheduled delivery time. Then, the delivery management server 410 determines whether delivery of the luggage to the designated vehicle 10 at a position based on the second information is possible based on the second information.

When it is determined that delivery of luggage to the designated vehicle 10 is not possible, the delivery management server 410 notifies a receiver of predetermined notification information. When it is determined that delivery of luggage to the designated vehicle 10 is possible, the delivery management server 410 may also notify the receiver of the predetermined notification information. Then, the delivery management server 410 transmits identification information of the designated vehicle 10 and identification information of a deliverer user to the central server 400. Then, the delivery management server 410 requests the central server 400 to transmit authentication information for locking and unlocking the designated vehicle 10 to the deliverer user terminal 200.

The central server 400 transmits authentication information of the designated vehicle 10 to the deliverer user terminal 200 based on the information transmitted from the delivery management server 410. Then, a deliverer can delivery luggage to the designated vehicle 10 by locking and unlocking the designated vehicle 10 using the authentication information the deliverer user terminal 200 receives. The authentication information may be transmitted from the central server 400 to the delivery management server 410 and then be transmitted from the delivery management server 410 to the deliverer user terminal 200. Here, the authentication information is digital information which is used to allow the onboard unit 10A to perform locking and unlocking of the designated vehicle 10 by being transmitted from the deliverer user terminal 200 to the onboard unit 10A and being subjected to authentication by the onboard unit 10A. Locking and unlocking of a designated vehicle 10 is a process of locking and unlocking a door of a cargo compartment of the designated vehicle 10.

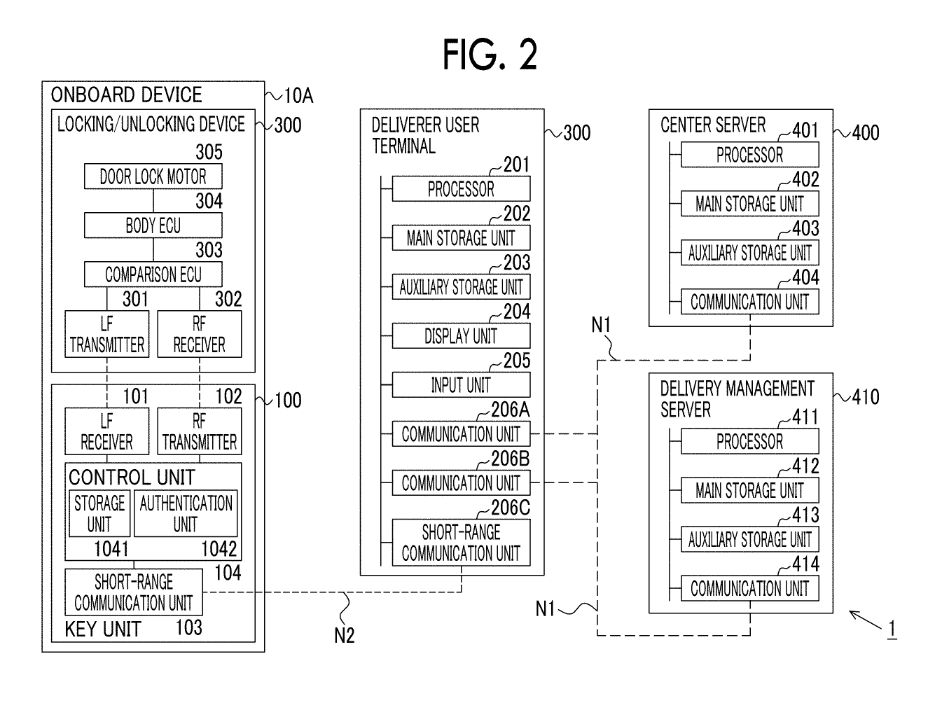

FIG. 2 is a diagram illustrating hardware configurations of an onboard unit 10A, a deliverer user terminal 200, the central server 400, and the delivery management server 410. A key unit 100 includes a radio interface such as an electronic key of a smart key, and can perform locking and unlocking of the designated vehicle 10 without using any physical key by communicating with an existing locking/unlocking device 300 of the onboard unit 10A. The key unit 100 performs short-range radio communication with a mobile terminal such as the deliverer user terminal 200 (hereinafter referred to as the deliverer user terminal 200 or the like) and determines whether it serves as an electronic key for the designated vehicle 10 based on a result of authentication for the deliverer user terminal 200 or the like.

Authentication information which is transmitted from the deliverer user terminal 200 or the like to the key unit 100 is compared with authentication information which is stored in advance in the key unit 100. When authentication has succeeded, the deliverer user terminal 200 or the like is authenticated. When the deliverer user terminal 200 or the like has been authenticated, the key unit 100 transmits an ID of an electronic key (hereinafter referred to as a key ID) for the designated vehicle 10 which is stored in advance in the key unit 100 and correlated with the authentication information to the locking/unlocking device 300 along with a locking/unlocking signal. The locking/unlocking device 300 locks and unlocks the designated vehicle 10 when the key ID received from the key unit 100 coincides with a key ID which is stored in advance in the locking/unlocking device 300. The key ID stored in advance in the key unit 100 may be encrypted with authentication information. In this case, when authentication for the deliverer user terminal 200 or the like has succeeded, the key unit 100 can decrypt the key ID with the authentication information and then transmit the decrypted key ID to the locking/unlocking device 300.

A terminal of a receiver who is a user of the designated vehicle 10 stores master authentication information which can be authenticated by the key unit 100, and the receiver can lock and unlock the designated vehicle 10 at any time. On the other hand, at the time of access to the cargo compartment of the designated vehicle 10, the deliverer user terminal 200 receives authentication information for locking and unlocking the designated vehicle 10 from the central server 400 or the delivery management server 410. The key unit 100 and the locking/unlocking device 300 operate with electric power which is supplied from a battery mounted in the designated vehicle 10.

The locking/unlocking device 300 is a device that locks and unlocks a door of the designated vehicle 10 and is an existing device constituting a part of a smart key system. Specifically, the locking/unlocking device 300 locks and unlocks the door of the designated vehicle 10 in accordance with a locking signal and an unlocking signal which are transmitted from an electronic key of a smart key which is carried by the user using radio waves of a radio frequency (hereinafter referred to as RF) band. The locking/unlocking device 300 also has a function of transmitting radio waves of a low frequency (hereinafter referred to as LF) band for detecting the electronic key of the smart key.

In this embodiment, instead of the electronic key, the key unit 100 controls locking and unlocking of the door of the designated vehicle 10 by transmitting and receiving radio waves of an RF band and an LF band to and from the locking/unlocking device 300. In the following description, unless otherwise mentioned, a communication destination of the locking/unlocking device 300 is limited to the key unit 100.

The locking/unlocking device 300 includes an LF transmitter 301, an RF receiver 302, a comparison ECU 303, a body ECU 304, and a door lock motor 305. The LF transmitter 301 is means that transmits radio waves of an LF band (for example, 100 KHz to 300 KHz) for detecting (polling) the key unit 100. The LF transmitter 301 is incorporated, for example, in a center console or in the vicinity of a steering wheel in a passenger compartment. The RF receiver 302 is means that receives radio waves of an RF band (for example, 100 MHz to 1 GHz) transmitted from the key unit 100. The RF receiver 302 is incorporated at any position in the passenger compartment.

The comparison ECU 303 is a computer that performs control for locking and unlocking the door of the designated vehicle 10 based on a signal (a locking signal or an unlocking signal) transmitted from the key unit 100 using radio waves of an RF band. The comparison ECU 303 is constituted, for example, by a microcomputer. In the following description, the locking signal and the unlocking signal are collectively referred to as a locking/unlocking signal. The term, locking/unlocking signal, represents at least one of the locking signal and the unlocking signal.

The comparison ECU 303 authenticates whether the locking/unlocking signal transmitted from the key unit 100 has been transmitted from a rightful device. Specifically, the comparison ECU 303 determines whether the key ID included in the locking/unlocking signal coincides with a key ID stored in advance in a storage unit of the comparison ECU 303. Then, the comparison ECU 303 transmits an unlocking command or a locking command to the body ECU 304 based on the determination result. The unlocking command or the locking command is transmitted via an onboard network such as a controller area network (CAN).

The body ECU 304 is a computer that executes body control of the designated vehicle 10. The body ECU 304 has a function of unlocking and locking the door of the designated vehicle 10 by controlling the door lock motor 305 based on the unlocking command or the locking command received from the comparison ECU 303. The door lock motor 305 is an actuator that locks and unlocks the door of the designated vehicle 10 (which includes a trunk door in addition to a boarding door or a rear gate). The door lock motor 305 operates based on a signal transmitted from the body ECU 304. The comparison ECU 303 and the body ECU 304 may be embodied as a single body.

The key unit 100 will be described now. The key unit 100 is a device that is disposed at a predetermined position (for example, inside a glove box) of the passenger compartment of the designated vehicle 10. The key unit 100 has a function of authenticating the deliverer user terminal 200 or the like by performing short-range radio communication with the deliverer user terminal 200 or the like and a function of transmitting a locking/unlocking signal using radio waves of an RF band based on the authentication result. The key unit 100 includes an LF receiver 101, an RF transmitter 102, a short-range communication unit 103, and a control unit 104.

The LF receiver 101 is means that receives a polling signal which is transmitted from the locking/unlocking device 300 using radio waves of an LF band. The LF receiver 101 includes an antenna for receiving radio waves of an LF band (hereinafter referred to as an LF antenna). The RF transmitter 102 is means that transmits a locking/unlocking signal to the key unit 100 using radio waves of an RF band.

The short-range communication unit 103 is means that communicates with the deliverer user terminal 200 or the like. The short-range communication unit 103 performs communication in a short range (at a distance at which communication can be performed between the interior and the exterior of the vehicle) using a predetermined radio communication standard.

In this embodiment, the short-range communication unit 103 performs data communication based on a Bluetooth (registered trademark) Low Energy standard (hereinafter referred to as BLE). BLE is a low-energy communication standard using Bluetooth, and is characterized in that communication can be started immediately when a communication partner is detected without requiring pairing between devices. In this embodiment, BLE is exemplified, but other radio communication standards can also be used. For example, near field communication (NFC), ultra wideband (UWB), and WiFi (registered trademark) may be used.

The control unit 104 is a computer that performs short-range radio communication with the deliverer user terminal 200 or the like via the short-range communication unit 103 and performs control for authenticating the deliverer user terminal 200 or the like and control for transmitting a locking/unlocking signal based on the authentication result. The control unit 104 is constituted, for example, by a microcomputer.

The control unit 104 includes a storage unit 1041 and an authentication unit 1042. A control program for controlling the key unit 100 is stored in the storage unit 1041. The control unit 104 may realize various functional units including the authentication unit 1042 by causing a CPU (not illustrated) to execute the control program stored in the storage unit 1041. For example, the control unit 104 realizes a function of receiving a polling signal transmitted as radio waves of an LF band from the locking/unlocking device 300 via the LF receiver 101, a function of transmitting a locking/unlocking signal as radio waves of an RF band to the locking/unlocking device 300 via the RF transmitter 102, a function of processing communication with the deliverer user terminal 200 or the like which is performed by the short-range communication unit 103, and a function of generating a locking/unlocking signal when authentication of the deliverer user terminal 200 or the like by the authentication unit 1042 has succeeded.

The authentication unit 1042 authenticates the deliverer user terminal 200 or the like based on authentication information included in a locking request or an unlocking request (hereinafter collectively referred to as a locking/unlocking request) transmitted from the deliverer user terminal 200 or the like. Specifically, the authentication unit 1042 compares the authentication information transmitted from the deliverer user terminal 200 or the like with the authentication information stored in the storage unit 1041 and determines that authentication has succeeded when the two pieces of authentication information satisfy a predetermined relationship. When the two pieces of authentication information do not satisfy the predetermined relationship, the authentication unit 1042 determines that authentication has failed. Here, the predetermined relationship includes a case in which the authentication information stored in the storage unit 1041 coincides with the authentication information transmitted from the deliverer user terminal 200 or the like, a case in which results of predetermined processes such as encryption and decryption using the two pieces of authentication information coincide with each other, and a case in which a result of decryption on one of the two pieces of authentication information coincides with that on the other thereof. When authentication of the deliverer user terminal 200 or the like by the authentication unit 1042 has succeeded, a locking/unlocking signal generated in response to a request received from the deliverer user terminal 200 or the like is transmitted to the locking/unlocking device 300 via the RF transmitter 102.

The key unit 100 transmits a key ID along with a locking/unlocking signal to the locking/unlocking device 300. The key ID may be stored in the key unit 100 in a plaintext state in advance or may be stored in a state in which it has been encrypted using a cipher specific to the deliverer user terminal 200 or the like. When the key ID is stored in an encrypted state, the encrypted key ID may be decrypted using authentication information transmitted from the deliverer user terminal 200 or the like to acquire the original key ID.

The delivery management server 410 has a general configuration of a computer. The delivery management server 410 includes a processor 411, a main storage unit 412, an auxiliary storage unit 413, and a communication unit 414. These elements are connected to each other via a bus. The main storage unit 412 and the auxiliary storage unit 413 are computer-readable recording mediums. The hardware configuration of a computer is not limited to the example illustrated in FIG. 2, and omission, substitution, or addition of elements may be appropriately performed thereon.

The delivery management server 410 can realize functions corresponding to a predetermined purpose by causing the processor 411 to load a program stored in a recording medium into a work area of the main storage unit 412 and to execute the loaded program and controlling the constituent units or the like through execution of the program.

The processor 411 is, for example, a central processing unit (CPU) or a digital signal processor (DSP). The processor 411 controls the delivery management server 410 and performs various information processing operations. The main storage unit 412 includes, for example, a random access memory (RAM) or a read only memory (ROM). The auxiliary storage unit 413 is, for example, an erasable programmable ROM (EPROM) or a hard disk drive (HDD). The auxiliary storage unit 413 can include a removable medium, that is, a portable recording medium. The removable medium is, for example, a universal serial bus (USB) memory or a disk recording medium such as a compact disc (CD) or a digital versatile disc (DVD).

The auxiliary storage unit 413 stores various programs, various types of data, and various tables on a recording medium in a readable and writable manner. An operating system (OS), various programs, various tables, and the like are stored in the auxiliary storage unit 413. Information stored in the auxiliary storage unit 413 may be stored in the main storage unit 412. Information stored in the main storage unit 412 may be stored in the auxiliary storage unit 413.

The communication unit 414 is connected to another device and controls communication between the delivery management server 410 and the other device. The communication unit 414 is, for example, a local area network (LAN) interface board and a radio communication circuit for radio communication. The LAN interface board or the radio communication circuit is connected to the network N1 such as the Internet which is a public communication network.

A sequence of processes which is performed by the delivery management server 410 may be performed by hardware or may be performed by software.

Similarly to the delivery management server 410, the central server 400 includes a processor 401, a main storage unit 402, an auxiliary storage unit 403, and a communication unit 404. The processor 401, the main storage unit 402, the auxiliary storage unit 403, and the communication unit 404 are the same as the processor 411, the main storage unit 412, the auxiliary storage unit 413, and the communication unit 414 of the delivery management server 410 and thus description thereof will not be repeated.

The deliverer user terminal 200 is a small computer such as a smartphone, a mobile phone, a tablet terminal, a personal information terminal, or a wearable computer (such as a smart watch). The receiver user terminal 210 may be a user terminal which has the same hardware configuration as the deliverer user terminal 200.

The deliverer user terminal 200 includes a processor 201, a main storage unit 202, an auxiliary storage unit 203, a display unit 204, an input unit 205, a communication unit 206A, a communication unit 206B, and a short-range communication unit 206C. The processor 201, the main storage unit 202, and the auxiliary storage unit 203 are the same as the processor 411, the main storage unit 412, and the auxiliary storage unit 413 of the delivery management server 410 and thus description thereof will not be repeated. The display unit 204 is, for example, a liquid crystal display (LCD) or an electroluminescence (EL) panel. The input unit 205 includes a touch panel and push buttons. The input unit 205 may include a video or image input unit such as a camera or a sound input unit such as a microphone. The communication unit 206A is a communication circuit that accesses the Internet, for example, via a mobile phone network with a base station as a terminal. The communication unit 206B is a communication circuit that accesses the Internet, for example, via a wireless or wired LAN and performs data communication with the delivery management server 410. The short-range communication unit 206C is a communication circuit that performs short-range communication in accordance with a predetermined communication standard. Examples of the predetermined communication standard include BLE and NFC.

The network N1 may be, for example, a global public communication network such as the Internet, and a wide area network (WAN) or other communication networks may be employed. The network N1 may include a telephone communication network for mobile phones and the like and a wireless communication network such as WiFi. The deliverer user terminal 200 can access the Internet via the telephone communication network for mobile phones and the like or the wireless communication network such as WiFi. The network N2 includes a communication network for BLE via which the deliverer user terminal 200 communicates with the onboard unit 10A. The deliverer user terminal 200 can communicate with the onboard unit 10A by BLE communication.

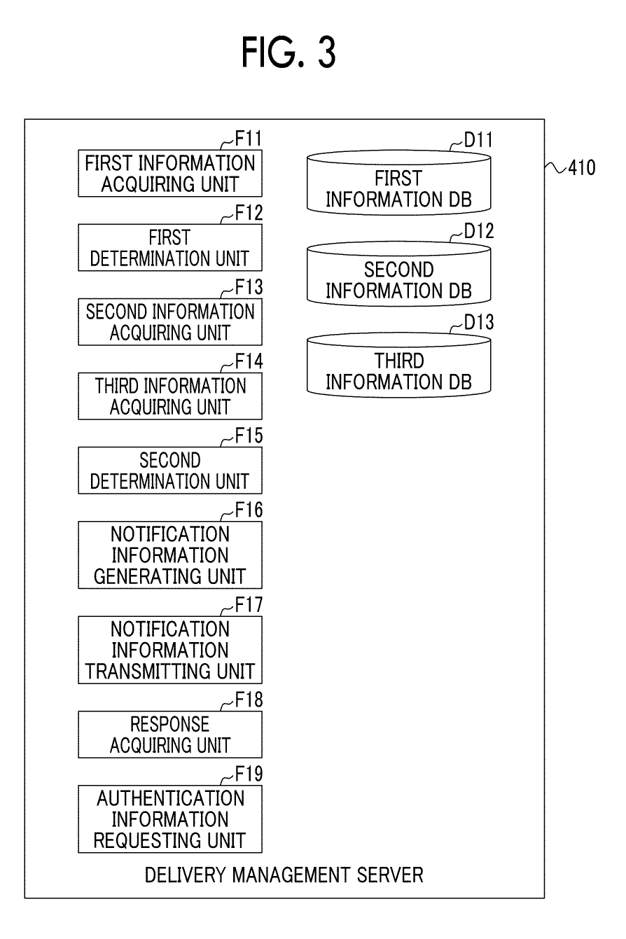

FIG. 3 is a diagram illustrating a functional configuration of the delivery management server. The delivery management server 410 includes a first information acquiring unit F11, a first determination unit F12, a second information acquiring unit F13, a third information acquiring unit F14, a second determination unit F15, a notification information generating unit F16, a notification information transmitting unit F17, a response acquiring unit F18, an authentication information requesting unit F19, a first information database D11, a second information database D12, and a third information database D13. The processor 411 of the delivery management server 410 performs processes of the first information acquiring unit F11, the first determination unit F12, the second information acquiring unit F13, the third information acquiring unit F14, the second determination unit F15, the notification information generating unit F16, the notification information transmitting unit F17, the response acquiring unit F18, and the authentication information requesting unit F19 by executing a computer program in the main storage unit 412. One of the functional units or some of processes thereof may be implemented by a hardware circuit.

The first information database D11, the second information database D12, and the third information database D13 are constructed by causing a program of a database management system (DBMS) which is executed by the processor 411 to manage data stored in the auxiliary storage unit 413. The first information database D11, the second information database D12, and the third information database D13 are, for example, relational databases.

One of the functional units of the delivery management server 410 or some of the processes thereof may be implemented by the central server 400 or another computer connected to the network N1.

The first information acquiring unit F11 acquires first information from a user (a receiver) who requests delivery of luggage using the delivery system 1. Here, the first information is information on a scheduled parking position of a designated vehicle 10 at the time of delivery of luggage by a deliverer. The first information includes the scheduled parking position and parking lot information of the scheduled parking position (such as a parking lot type such as a surface type or a mechanical type, a size of a parking space, and whether an authority is required for entering the parking lot). The receiver can also designate the first information using an application for using a service provided by the delivery system 1 (hereinafter also referred to as a predetermined application) at the same time as designating a cargo compartment of a vehicle which is a delivery destination of luggage. The first information acquiring unit F11 is an example of a first acquisition unit.

The first determination unit F12 determines whether delivery of luggage to the cargo compartment of the designated vehicle 10 by a deliverer is possible based on the first information. For example, when the parking lot type acquired by the first information acquiring unit F11 is a mechanical type, the first determination unit F12 determines that delivery of luggage to the designated vehicle 10 is not possible. In this case, the notification information transmitting unit F17 which will be described later notifies the receiver of a notification thereof. For example, the receiver is prompted to designate a place at which delivery of luggage to the cargo compartment of the designated vehicle 10 is possible as a scheduled parking position. Then, the receiver can designate a changed scheduled parking position. Then, the first determination unit F12 performs the above-mentioned determination based on the changed first information. When it is determined that delivery of luggage to the designated vehicle 10 is possible, the first information at that time is registered in the first information database D11. The first determination unit F12 is an example of a first determination unit.

The second information acquiring unit F13 acquires second information. Here, the second information is information on position information of the designated vehicle 10, and is position information of the designated vehicle 10 at the second timing in this embodiment. The position information is calculated, for example, by a GPS device (not illustrated) of the onboard unit 10A by receiving signals from GPS satellites. The second information acquiring unit F13 registers the acquired second information in the second information database D12. The second information acquiring unit F13 is an example of a second acquisition unit.

The third information acquiring unit F14 acquires third information. Here, the third information is predetermined information on a parking lot. The third information includes information such as a position of a parking lot, a parking lot type, a size of a parking space, and whether an authority is required for entering a parking lot. The third information acquiring unit F14 acquires such third information in advance for each parking lot included in predetermined map information. The third information acquiring unit F14 registers the acquired third information in the third information database D13. The third information acquiring unit F14 is an example of a third acquisition unit.

The second determination unit F15 determines whether delivery of luggage to the cargo compartment of the designated vehicle 10 by a deliverer is possible based on the second information which is acquired by the second information acquiring unit F13 and is registered in the second information database D12 and the third information which is acquired by the third information acquiring unit F14 and is registered in the third information database D13. Specifically, the second determination unit F15 compares current position information of the designated vehicle 10 with the parking lot position information included in the predetermined map information and specifies a parking lot corresponding to the current position information. The parking lot which is specified in this way is compared with the third information. For example, when the parking lot type of the specified parking lot is a mechanical type, the second determination unit F15 determines that delivery of luggage to the designated vehicle 10 is not possible. The determination result from the second determination unit F15 is transmitted and received to and from the notification information generating unit F16 which will be described later. The second determination unit F15 is an example of a second determination unit.

The notification information generating unit F16 generates predetermined notification information which is transmitted to the receiver or the deliverer. Here, the predetermined notification information is information based on the determination result from the first determination unit F12 or the second determination unit F15 or information of the designated vehicle 10 for the deliverer, and details thereof will be described later. The notification information transmitting unit F17 notifies the receiver or the deliverer of the notification information generated by the notification information generating unit F16. The notification information transmitting unit F17 can notify the receiver or the deliverer of the notification information by transmitting the notification information to the deliverer user terminal 200 or the receiver user terminal 210. The notification information generating unit F16 and the notification information transmitting unit F17 are examples of a first notification unit and a second notification unit, respectively.

The response acquiring unit F18 acquires a response from the receiver who has been notified of the predetermined notification information. Details thereof will be described later.

The authentication information requesting unit F19 requests the central server 400 to transmit authentication information for locking and unlocking the designated vehicle 10 to the deliverer user terminal 200.

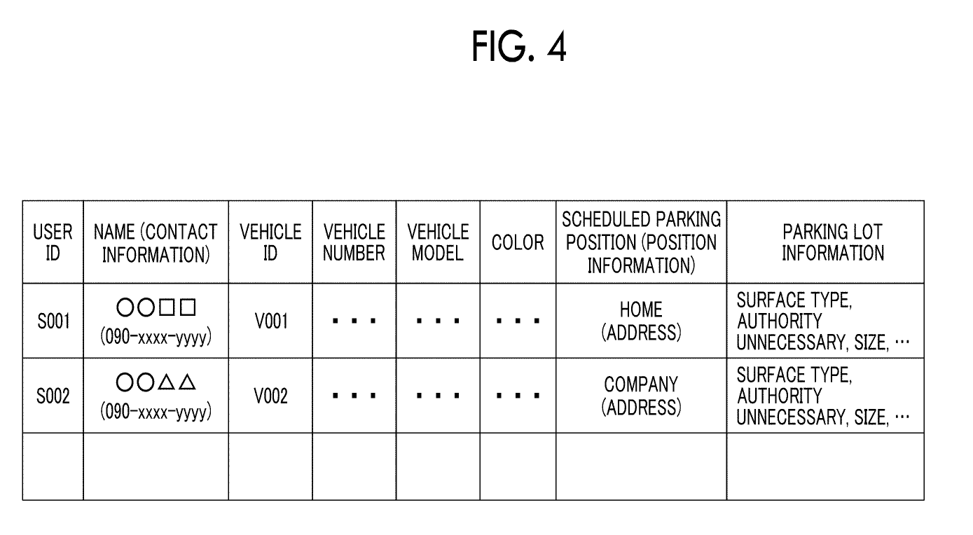

The first information database D11 is a database that stores first information. The first information database D11 includes a first information table illustrated in FIG. 4. Information which is stored in the first information table is not limited to the example illustrated in FIG. 4 and addition, modification, and deletion of fields may be appropriately performed thereon. Identification information of receivers may be managed by individual tables.

The first information table illustrated in FIG. 4 includes fields of user ID, name (and contact information), vehicle ID, vehicle number, vehicle model, color, scheduled parking position (position information), and parking lot information. The user ID is an ID for identifying a receiver user. The name is a name of the receiver user. The contact information is, for example, a mobile phone number or an e-mail address of the receiver user. The vehicle ID is an ID for identifying a vehicle. The vehicle number, the vehicle model, and the color are information which is used to specify the vehicle, and the vehicle ID is set for each vehicle number. The vehicle ID is correlated with authentication information for the vehicle in advance in the central server 400. The scheduled parking position is a position at which the designated vehicle 10 is scheduled to be parked at the time of delivery of luggage by a deliverer and, for example, the home or company is designated along with an address thereof. The parking lot information is parking lot information of the scheduled parking position and includes information such as a parking lot type, a size of a parking space, and whether an authority is required for entering the parking lot. Since the scheduled parking position at which it is determined that delivery of luggage to the designated vehicle 10 is possible is registered as first information in the first information database D11 as described above, the parking lot type registered in the parking lot information is a surface type and an authority for entrance is not necessary.

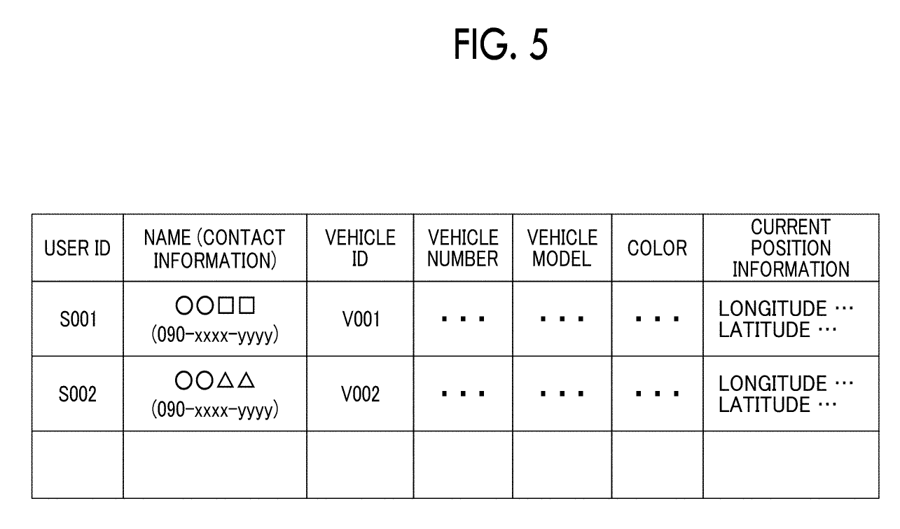

The second information database D12 is a database that stores second information. The second information database D12 includes a second information table illustrated in FIG. 5. Information which is stored in the second information table is not limited to the example illustrated in FIG. 5 and addition, modification, and deletion of fields may be appropriately performed thereon. Identification information of receivers may be managed by individual tables.

The second information table illustrated in FIG. 5 includes fields of user ID, name (and contact information), vehicle ID, vehicle number, vehicle model, color, and current position information. The fields of user ID, name (and contact information), vehicle ID, vehicle number, vehicle model, and color are the same as described above with reference to FIG. 4. The current position information is position information of the designated vehicle 10 at the second timing.

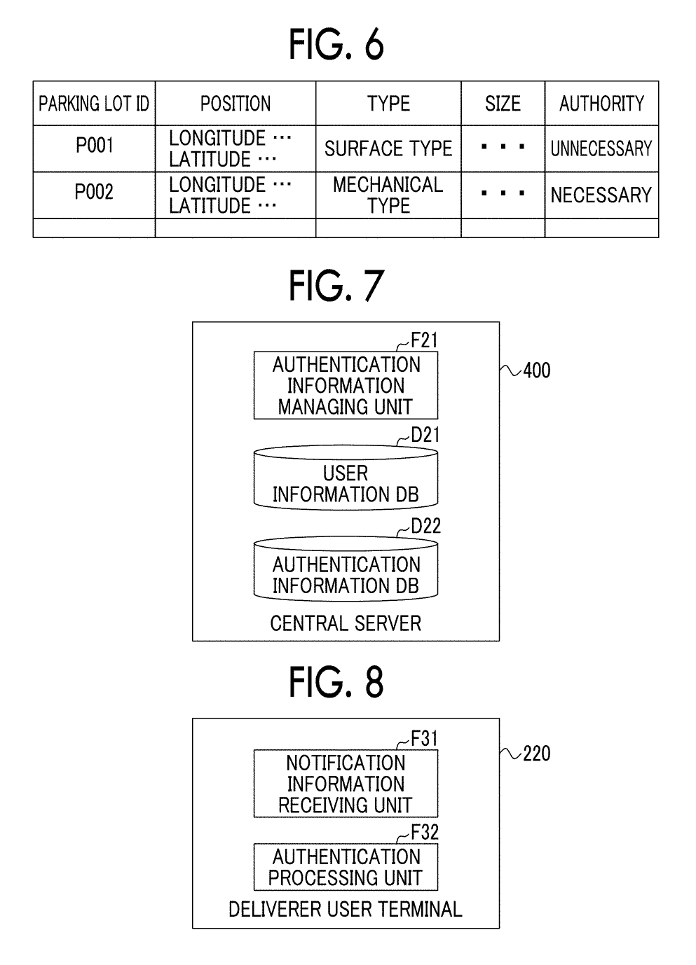

The third information database D13 is a database that stores third information. The third information database D13 includes a third information table illustrated in FIG. 6. Information which is stored in the third information table is not limited to the example illustrated in FIG. 6 and addition, modification, and deletion of fields may be appropriately performed thereon.

The third information table illustrated in FIG. 6 includes fields of parking lot ID, position, type, size, and authority. The parking lot ID is an ID for identifying each parking lot included in predetermined map information. The position is a position of a parking lot. The type is a parking lot type such as a surface type or a mechanical type. The size is a size of a parking space. The authority is information on whether an authority is required for entering the parking lot.

FIG. 7 is a diagram illustrating a functional configuration of the central server. The central server 400 includes an authentication information managing unit F21, a user information database D21, and an authentication information database D22 as functional units. The processor 401 of the central server 400 performs processes of the authentication information managing unit F21, the user information database D21, and the authentication information database D22 by executing a computer program. One of the functional units or some of the processes thereof may be implemented by a hardware circuit.

One of the functional units of the central server 400 or some of the processes thereof may be implemented by the delivery management server 410 or another computer connected to the network N1.

The authentication information managing unit F21 receives a request for transmission of authentication information from the delivery management server 410. The authentication information managing unit F21 receives information of a user terminal which is a destination of authentication information, and identification information of a vehicle which is locked or unlocked along with the request for transmission of authentication information. The authentication information managing unit F21 transmits authentication information (terminal authentication information) corresponding to the key unit of the vehicle which is locked or unlocked to the user terminal. The authentication information may be transmitted to the delivery management server 410 and then be transmitted from the delivery management server 410 to the user terminal.

The user information database D21 stores identification information of a user and identification information of a vehicle correlated with the user. The authentication information database D22 stores authentication information for the vehicle. The authentication information for the vehicle is information correlated with the identification information of the vehicle and can be set to, for example, information specific to the key unit of the onboard unit thereof.

FIG. 8 is a diagram illustrating a functional configuration of a deliverer user terminal. The deliverer user terminal 200 includes a notification information receiving unit F31 and an authentication processing unit F32 as functional units. The processor 201 of the deliverer user terminal 200 performs processes of the notification information receiving unit F31 and the authentication processing unit F32 by executing a computer program in the main storage unit 202. One of the functional units or some of the processes thereof may be implemented by a hardware circuit.

The notification information receiving unit F31 receives notification information transmitted from the delivery management server 410. Then, the notification information receiving unit F31 displays the received notification information on the deliverer user terminal 200. Examples of information displayed on the deliverer user terminal 200 include a parking position of a designated vehicle 10 and a vehicle number of the designated vehicle 10. Here, the parking position of the designated vehicle 10 may be displayed by an address or an address for linking to a map application correlated with the predetermined application. In this case, a deliverer can ascertain the parking position of the designated vehicle 10 on a map displayed by the map application.

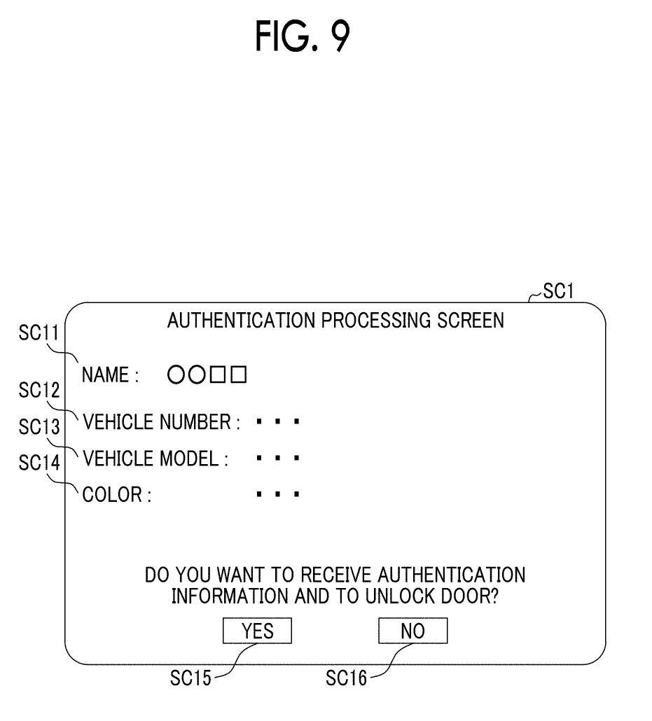

The authentication processing unit F32 receives authentication information for authentication by the key unit 100 of the designated vehicle 10. The authentication processing unit F32 provides an interface for allowing the deliverer to perform unlocking or locking of the designated vehicle 10 using the authentication information received by the deliverer. The deliverer can unlock or lock the vehicle, for example, through an operation on an authentication processing screen SC1 illustrated in FIG. 9.

FIG. 9 is a diagram illustrating an authentication processing screen. The authentication processing screen SC1 illustrated in FIG. 9 is a screen for performing unlocking of the designated vehicle 10. On the authentication processing screen SC1, fields of receiver information SC11, vehicle number SC12, vehicle model SC13, color SC14, an unlocking button SC15 labeled with “YES,” and a cancel button SC16 labeled with “NO” are displayed. The deliverer can specify the designated vehicle 10 based on the vehicle number SC12, the vehicle model SC13, and the color SC14 displayed on the authentication processing screen SC1.

When the unlocking button SC15 is pressed, the short-range communication unit 103 of the key unit 100 receives authentication information from the deliverer user terminal 200. The authentication unit 1042 of the key unit 100 performs an authentication process by comparing the received authentication information with authentication information stored in the storage unit 1041. When authentication has succeeded, the authentication unit 1042 of the key unit 100 transmits an unlocking signal to the locking/unlocking device 300 along with a key ID correlated with the authentication information, and the designated vehicle 10 is unlocked when authentication of the key ID has succeeded.

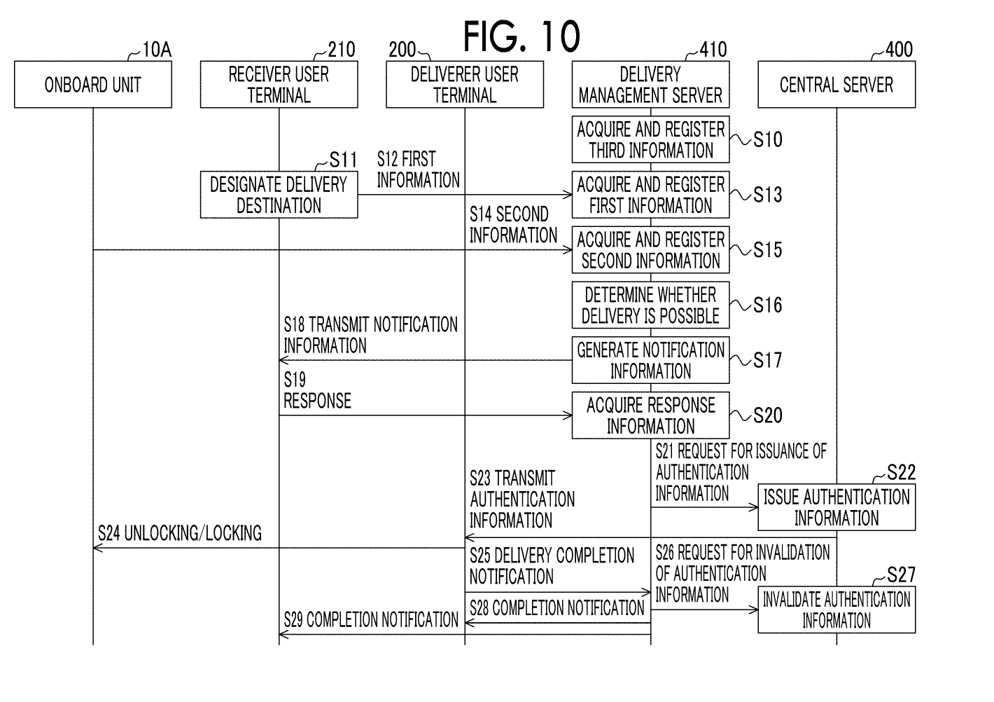

FIG. 10 is a diagram illustrating a flow of operations in the delivery system according to this embodiment. FIG. 10 illustrates a flow of operations between the elements in the delivery system 1 and processes which are performed by the elements.

In this embodiment, the delivery management server 410 acquires third information and registers the acquired third information in the third information database D13 in advance (S10). The delivery management server 410 can acquire the third information for each parking lot included in predetermined map information.

A user (a receiver) who requests delivery of luggage using the delivery system 1 designates a delivery destination using a receiver user terminal 210 (S11). In this embodiment, the receiver designates a cargo compartment of a vehicle which is owned by the receiver as a delivery destination and designates first information (A scheduled parking position and parking lot information of the scheduled parking position) at the same time. The first information is transmitted to the delivery management server 410 by the receiver user terminal 210 (S12). The delivery management server 410 acquires the first information and registers the acquired first information in the first information database D11 (S13). At this time, as described above, the first determination unit F12 determines whether delivery of luggage to the cargo compartment of the designated vehicle 10 by a deliverer is possible based on the first information transmitted from the receiver user terminal 210. Then, when it is determined that delivery of luggage to the designated vehicle 10 is possible, the first information at that time is registered in the first information database D11.

The delivery management server 410 acquires second information at the second timing and registers the acquired second information in the second information database D12 (S15). As described above, the second timing is a predetermined timing after the first timing and before a scheduled delivery time and is, for example, a time close to the scheduled delivery time. The second information in this embodiment is position information of the designated vehicle 10 at the second timing as described above. For example, when a request for transmission of second information is transmitted from the delivery management server 410 to the onboard unit 10A at the second timing, a GPS device of the onboard unit 10A calculates position information of the designated vehicle 10 at that time. Here, when the designated vehicle 10 is moving, the position of the designated vehicle 10 changes thereof. Therefore, in this embodiment, when the designated vehicle 10 is in a parked state, the position information of the designated vehicle 10 is calculated. By transmitting the position information of the designated vehicle 10 calculated in this way from the onboard unit 10A to the delivery management server 410 (S14), the delivery management server 410 can acquire the second information. It can be determined that the designated vehicle 10 is in the parked state when a system power supply of the designated vehicle 10 is turned off, when an engine of the designated vehicle 10 is turned off, when a parking brake of the designated vehicle 10 is turned on, or when the designated vehicle 10 has been stopped for a predetermined time or more.

The delivery management server 410 determines whether delivery of luggage to the cargo compartment of the designated vehicle 10 by a deliverer is possible based on the second information registered in the second information database D12 and the third information registered in the third information database D13 (S16). The determination is performed by the second determination unit F15 and details thereof are the same as described above.

The delivery management server 410 generates notification information based on the determination result in S16 (S17). Here, when the position based on the second information (the position of the designated vehicle 10 at the second timing) is the same as the scheduled parking position and it is determined that delivery of luggage to the designated vehicle 10 is possible in the process of S16, notification information indicating that delivery of luggage to the designated vehicle 10 at the scheduled parking position is possible is generated in the process of S17. When the position based on the second information (the position of the designated vehicle 10 at the second timing) is different from the scheduled parking position and it is determined that delivery of luggage to the designated vehicle 10 at the position based on the second information is possible in the process of S16, notification information indicating that delivery of luggage to the designated vehicle 10 at the position based on the second information is possible is generated in the process of S17. Then, the delivery management server 410 transmits the generated notification information to the receiver user terminal 210 (S18).

On the other hand, when the position based on the second information (the position of the designated vehicle 10 at the second timing) is different from the scheduled parking position and it is determined that delivery of luggage to the designated vehicle 10 at the position based on the second information is not possible in the process of S16, notification information indicating that delivery of luggage to the designated vehicle 10 is not possible is generated in the process of S17. Then, the delivery management server 410 transmits the generated notification information to the receiver user terminal 210 (S18).

A receiver who has been notified of the notification information transmits a response to the notification information to the delivery management server 410 using the receiver user terminal 210 (S19). For example, a receiver who has been notified of information indicating that delivery of luggage to the designated vehicle 10 at the scheduled parking position or the designated vehicle 10 at the position based on the second information is possible can return a response indicating agreement thereto. On the other hand, for example, a receiver who has been notified of information indicating that delivery of luggage to the designated vehicle 10 is not possible can move the designated vehicle 10 to a place at which delivery of luggage to the designated vehicle 10 is possible and return a response indicating that fact to the delivery management server 410. Alternatively, the receiver can return a response for designating a delivery date and time or a delivery place again. Then, the delivery management server 410 acquires a response transmitted from the receiver user terminal 210 as response information (S20). The delivery management server 410 may determine whether delivery of luggage to the cargo compartment of the designated vehicle 10 is possible again based on the acquired response information. Accordingly, even when the designated vehicle 10 moves away from the scheduled parking position designated at the first timing at the time of actual delivery of luggage, it is possible to deliver luggage.

Then, the delivery management server 410 transmits identification information of the designated vehicle 10 and information of the deliverer user terminal 200 which is a destination of authentication information to the central server 400 and requests the central server 400 to transmit authentication information to the deliverer user terminal 200 (S21). When a request for transmission of authentication information is received, the central server 400 issues authentication information based on the received identification information of the designated vehicle 10 (S22). The central server 400 transmits the issued authentication information to the deliverer user terminal 200 (S23).

The deliverer user terminal 200 transmits the authentication information transmitted to the deliverer user terminal 200 to the onboard unit 10A (the key unit 100) of the designated vehicle 10 and requests unlocking of the vehicle. When authentication of the deliverer user terminal 200 using the authentication information has succeeded, the designated vehicle 10 is unlocked (S24). Accordingly, a deliverer can deliver luggage to the cargo compartment of the designated vehicle 10. When the deliverer delivers luggage to the cargo compartment of the designated vehicle 10, the deliverer can lock the designated vehicle 10 (S24). When delivery of luggage to the cargo compartment of the designated vehicle 10 has been completed, the deliverer can transmit a delivery completion notification to the delivery management server 410 using a predetermined application in the deliverer user terminal 200 (S25).

When the delivery completion notification has been received from the deliverer user terminal 200, the delivery management server 410 requests the central server 400 to invalidate the authentication information transmitted in S23 (S26). Then, the central server 400 invalidates the authentication information (S27). The delivery management server 410 or the deliverer user terminal 200 can invalidate the authentication information by deleting the authentication information received from the central server 400 in response to an instruction from the central server 400. The central server 400 can perform exclusive control for preventing authentication information from being issued double by managing whether authentication information is to be invalidated or can update authentication information and notify the updated authentication information to the key unit 100. Then, when invalidation of the authentication information has been completed, a completion notification is transmitted from the delivery management server 410 to the deliverer user terminal 200 and the receiver user terminal 210 (S28 and S29).

In the process flow illustrated in FIG. 10, it is determined whether delivery of luggage to a cargo compartment of a designated vehicle 10 by deliverer is possible based on position information of the designated vehicle 10 at the second timing (second information) and third information, but this embodiment is not limited thereto. For example, the delivery management server 410 may request a receiver to ascertain a scheduled parking position using a receiver user terminal 210 at the second timing and acquire a response thereto from the receiver as second information. Then, the delivery management server 410 may perform the determination based on the second information. At this time, when the scheduled parking position is changed by the receiver, the delivery management server 410 acquires the changed scheduled parking position as second information.

In the above-mentioned delivery system 1, even when a designated vehicle 10 moves away from a scheduled parking position designated at the first timing at the time of actual delivery of luggage, it is possible to delivery luggage and thus to minimize a likelihood that luggage will not be delivered to a cargo compartment of a vehicle.

A program causing a computer or other machine or device (hereinafter referred to as a computer or the like) to execute any one of the above-mentioned functions can be recorded on a recording medium which can be read by a computer or the like. By causing the computer or the like to read and execute the program of the recording medium, the functions can be provided.

Here, a recording medium which can be read by a computer or the like refers to a non-transitory recording medium which can store information such as data or programs in an electrical, magnetic, optical, mechanical, or chemical action and be read by the computer or the like. Examples of the recording medium which can be detached from the computer or the like include a flexible disk, a magneto-optical disc, a CD-ROM, a CD-R/W, a DVD, a Blu-ray disc, a DAT, a 8 mm tape, and a memory card such as a flash memory. Examples of the recording medium which is fixed to the computer or the like include a hard disk and a read only memory (ROM). A solid state drive (SSD) can be used as a recording medium which can be detached from the computer or the like and can also be used as a recording medium which is fixed to the computer or the like.

In the first embodiment, when an authentication process in the key unit 100 has succeeded, a designated vehicle 10 is unlocked by the locking/unlocking device 300. However, in this other example, the locking/unlocking device 300 may perform the processes in the key unit 100. That is, the locking/unlocking device 300 may include a control unit for authenticating authentication information received from a deliverer user terminal 200, and the control unit may transmit an unlocking command or a locking command to the body ECU 304 via an onboard network such as a CAN when authentication of the deliverer user terminal 200 has succeeded.

With the delivery system 1 according to the above example, it is possible to deliver luggage with a simple configuration without installing the key unit 100.

In the first embodiment, a deliverer user terminal 200 receives authentication information from the central server 400, a locking/unlocking signal is transmitted from the key unit 100 to the locking/unlocking device 300 when the deliverer user terminal 200 has been authenticated based on the received authentication information, and the designated vehicle 10 is locked or unlocked. In this other example, the authentication information includes information of a key ID for locking/unlocking the designated vehicle 10, not information for authenticating the deliverer user terminal 200.

In this case, the deliverer user terminal 200 receives authentication information including a key ID for locking/unlocking the designated vehicle 10 from the central server 400, and transmits the received key ID along with a locking/unlocking signal to the locking/unlocking device 300. The locking/unlocking device 300 compares the received key ID with a key ID stored in advance in the locking/unlocking device 300 and locks and unlocks the designated vehicle 10 when the two key IDS coincide with each other. The key ID is transmitted and received in an encrypted state between the deliverer user terminal 200 and the central server 400 or the locking/unlocking device 300. The authentication information managing unit F21 of the central server 400 may generate a one-time key, for example, by encrypting the key ID using a predetermined algorithm along with time information. The locking/unlocking device 300 decrypts the received one-time key using the same algorithm as in the central server 400 and compares the decrypted one-time key with the key ID stored in advance in the locking/unlocking device 300. The one-time key may be transmitted from the central server 400 to the delivery management server 410 and may be transmitted from the delivery management server 410 to the deliverer user terminal 200.

By including a one-time key generated from a key ID and time information in authentication information, the central server 400 can generate authentication information which is temporarily valid for each request for use and transmit the generated authentication information to the deliverer user terminal 200.

In the first embodiment and the other example of the first embodiment, the central server 400 transmits authentication information for a deliverer user terminal 200 corresponding to fixed authentication information specific to the key unit 100 or a key ID stored in advance in the locking/unlocking device 300 of the designated vehicle 10 to the deliverer user terminal 200. However, authentication information transmitted between the deliverer user terminal 200 and the key unit 100 is not limited thereto. In this other example, for example, the central server 400 may generate new authentication information and issue the new authentication information to the deliverer user terminal 200 when a request for issuance of authentication information is received. In this case, the central server 400 can transmit authentication information for the key unit 100 corresponding to the new authentication information for the deliverer user terminal 200 to the key unit 100 via an onboard communication device (not illustrated) which can communicate with the network N1 connected to the central server 400 and store the authentication information therein. In this case, the key unit 100 can be connected to an onboard communication device via a CAN or the like. Here, the central server 400 may generate new authentication information based on identification information for identifying the designated vehicle 10 and time information and transmit the new authentication information and the time information to the deliverer user terminal 200. In this case, the key unit 100 can generate new authentication information using the same algorithm as in the central server 400. The deliverer user terminal 200 can transmit the new authentication information and the time information to the key unit 100 and be subjected to authentication.

In the first embodiment, position information of a designated vehicle 10 at the second timing is acquired as the second information. On the other hand, in an embodiment, position information of a designated vehicle 10 based on a movement schedule of the designated vehicle 10 is acquired as the second information. This will be described below in detail with reference to FIG. 10.

In this embodiment, in the process of S15 in FIG. 10, position information of a designated vehicle 10 based on a movement schedule of the designated vehicle 10 is acquired as the second information. Here, the movement schedule of the designated vehicle 10 is prepared, for example, by a navigation system of the onboard unit 10A of the designated vehicle 10. Specifically, by allowing a user of the designated vehicle 10 to input a destination to a navigation system, the system prepares a movement schedule such as a movement route to the destination or a necessary time thereto. When a request for transmission of second information is transmitted from the delivery management server 410 to the onboard unit 10A at the second timing, the onboard unit 10A calculates position information of the designated vehicle 10 at a scheduled delivery time based on the movement schedule and transmits the calculated position information to the delivery management server 410.

Then, the delivery management server 410 determines whether delivery of luggage to the cargo compartment of the designated vehicle 10 by a deliverer is possible based on the second information which is acquired as described above and registered in the second information database D12 and the third information registered in the third information database D13 (S16).

With this delivery system 1, it is possible to minimize a likelihood that luggage will not be delivered to a cargo compartment of a vehicle.

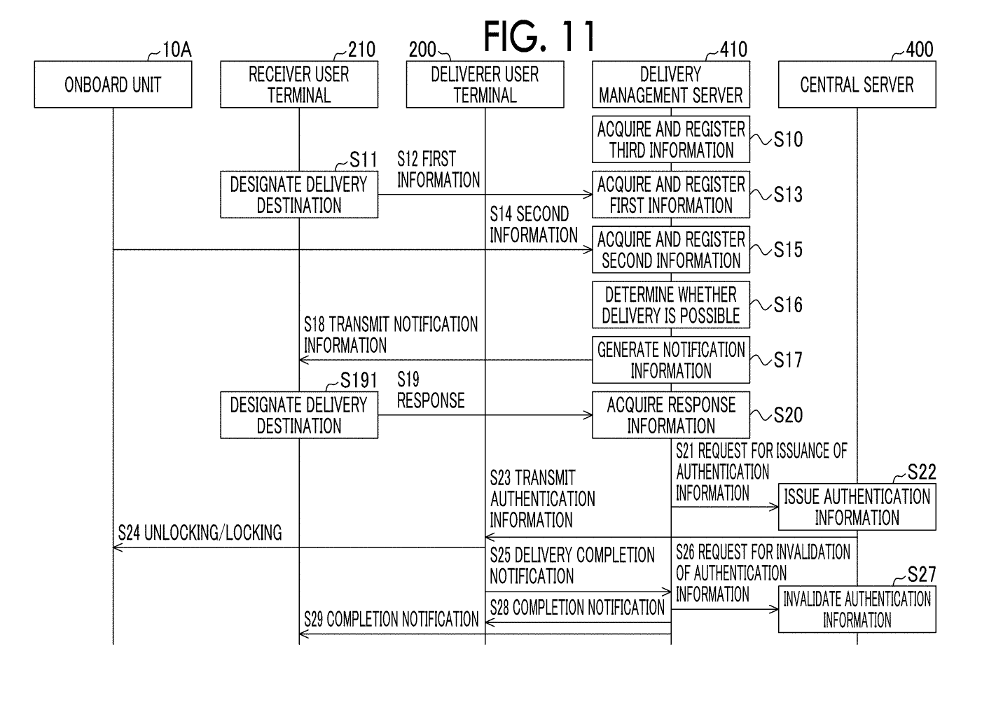

In the first embodiment and the second embodiment, a cargo compartment of a vehicle which is owned by a receiver is designated as a delivery destination. On the other hand, in this embodiment, a cargo compartment of a vehicle which is owned by a third party other than a receiver is designated as a delivery destination. This will be described below in detail with reference to FIG. 11.

FIG. 11 is a diagram illustrating a flow of operations in a delivery system according to this embodiment. Similarly to FIG. 10, FIG. 11 illustrates a flow of operations between elements of the delivery system 1 and processes which are performed by the elements. In the following description, substantially the same operations and processes as described above with reference to FIG. 10 will be referred to by the same reference signs and detailed description thereof will not be repeated.

In this embodiment, a receiver can set a vehicle serving as a delivery destination of luggage (a designated vehicle) from a plurality of vehicles registered in the delivery system 1. Accordingly, when information indicating that delivery of luggage to the designated vehicle 10 is not possible has been transmitted in the process of S18, the receiver changes the designated vehicle 10 (S191). Then the delivery management server 410 acquires the information as response information (S20). The delivery management server 410 can determine whether delivery of luggage to the cargo compartment of the changed designated vehicle 10 is possible again.

With this delivery system 1, it is also possible to minimize a likelihood that luggage will not be delivered to a cargo compartment of a vehicle.

What is claimed is:

1. A delivery system in which a predetermined area of a vehicle is used as a delivery place of luggage, the delivery system comprising:
a first acquisition unit configured to acquire first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage;
a first determination unit configured to determine, based on the first information acquired by the first acquisition unit at the first timing, whether delivery of the luggage, by the deliverer, to the designated vehicle parked at the scheduled parking position when the deliverer delivers the luggage is possible; a second acquisition unit configured to acquire, at a second timing, second information on position information of the designated vehicle, and the second timing being a predetermined timing after the first timing and before the luggage is delivered to the receiver;
a second determination unit configured to determine, based on the second information acquired by the second acquisition unit at the second timing, whether delivery of the luggage, by the deliverer, to the designated vehicle at a position indicated by the second information is possible;
a first notification unit configured to transmit predetermined first notification information to the receiver when the second determination unit determines that delivery of the luggage to the designated vehicle is not possible; and
an authentication information issuing unit configured to issue authentication information for locking and unlocking the predetermined area of the designated vehicle to a terminal of the deliverer.

2. The delivery system according to claim 1, further comprising a third acquisition unit configured to acquire third information which is predetermined information on a parking lot, wherein
the second acquisition unit is configured to acquire, as the second information, current position information which is information related to a position of the designated vehicle at a time of the luggage to be delivered, and
the second determination unit is configured to determine whether delivery of the luggage to the designated vehicle is possible based on the current position information acquired by the second acquisition unit and the third information acquired by the third acquisition unit.

3. The delivery system according to claim 2, wherein the second acquisition unit is configured to acquire the current position information as the second information when the designated vehicle is in a parked state.

4. The delivery system according to claim 3, wherein the parked state is a state in which at least one of condition, condition, condition, and condition is satisfied, the condition being a condition that a system power supply of the designated vehicle is turned off, the condition being a condition that an engine of the designated vehicle is turned off, the condition being a condition that a parking brake of the designated vehicle is turned on, and the condition being a condition that the designated vehicle has been stopped for a predetermined time or more.

5. The delivery system according to claim 1, further comprising a third acquisition unit configured to acquire third information which is predetermined information on a parking lot, wherein
the second acquisition unit is configured to acquire, as the second information, movement position information which is position information of the designated vehicle based on a movement schedule of the designated vehicle, and
the second determination unit is configured to determine whether delivery of the luggage to the designated vehicle is possible based on the movement position information acquired by the second acquisition unit and the third information acquired by the third acquisition unit.

6. The delivery system according to claim 1, further comprising a second notification unit configured to transmit predetermined second notification information to the receiver when both of conditions and are satisfied, the condition being a condition that a position of the designated vehicle indicated by the second information acquired by the second acquisition unit is different from the scheduled parking position, and the condition being a condition that the second determination unit determines that delivery of the luggage to the designated vehicle is possible.

7. The delivery system according to claim 1, wherein the designated vehicle is a vehicle which is owned by the receiver.

8. The delivery system according to claim 1, wherein the designated vehicle is a vehicle which is owned by a third party other than the receiver.

9. The delivery system according to claim 1, further comprising a change receiving unit configured to receive change of the designated vehicle when the second determination unit determines that delivery of the luggage to the designated vehicle is not possible.

10. The delivery system according to claim 1, wherein the second determination unit is configured to determine whether the delivery of luggage, by the deliverer, to the designated vehicle at the position indicated by the second information is possible when the first determination unit determines that the delivery of the luggage, by the deliverer, to the designated vehicle parked at the scheduled parking position when the deliverer delivers the luggage is possible.

11. The delivery system according to claim 1, wherein the authentication information issuing unit is configured to issue the authentication information to the terminal of the deliverer when the second determination unit determines that the delivery of luggage, by the deliverer, to the designated vehicle at the position indicated by the second information is possible.

12. An information processing device that controls a system in which a predetermined area of a vehicle is used as a delivery place of luggage, the information processing device comprising:
a first acquisition unit configured to acquire first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage;
a first determination unit configured to determine, based on the first information acquired by the first acquisition unit at the first timing, whether delivery of the luggage, by the deliverer, to the designated vehicle parked at the scheduled parking position when the deliverer delivers the luggage is possible; a second acquisition unit configured to acquire, at a second timing, second information on position information of the designated vehicle, and the second timing being a predetermined timing after the first timing and before the luggage is delivered to the receiver;
a second determination unit configured to determine, based on the second information acquired by the second acquisition unit at the second timing, whether delivery of the luggage, by the deliverer, to the designated vehicle at a position indicated by the second information is possible;
a first notification unit configured to transmit predetermined first notification information to the receiver when the second determination unit determines that delivery of the luggage to the designated vehicle is not possible; and
an authentication information issuing unit configured to issue authentication information for locking and unlocking the predetermined area of the designated vehicle to a terminal of the deliverer.

13. An information processing method of controlling a system in which a predetermined area of a vehicle is used as a delivery place of luggage, the information processing method comprising:
causing a computer to acquire first information at a first timing, the first timing being a predetermined timing before the luggage is delivered to a receiver, the first information being information a scheduled parking position of a designated vehicle when the luggage is delivered by a deliverer, and the designated vehicle being a delivery destination of the luggage;
causing the computer to determine, based on the first information acquired at the first timing, whether delivery of the luggage, by the deliverer, to the designated vehicle parked at the scheduled parking position when the deliverer delivers the luggage is possible;
causing the computer to acquire, at a second timing, second information on position information of the designated vehicle, and the second timing being a predetermined timing after the first timing and before the luggage is delivered to the receiver;
causing the computer to determine, based on the second information acquired at the second timing, whether delivery of the luggage, by the deliverer, to the designated vehicle at a position indicated by the second information is possible;
causing the computer to transmit predetermined first notification information to the receiver when the computer determines that delivery of the luggage to the designated vehicle is not possible; and
causing the computer to issue authentication information for locking and unlocking the predetermined area of the designated vehicle to a terminal of the deliverer.

14. A non-transitory recording medium storing a program for controlling a system in which a predetermined area of a vehicle is used as a delivery place of luggage, the program causing a computer to perform:
acquiring first information at a first timing, the first timing being a predetermined timing before the luggage is delivered to a receiver, the first information being information on a scheduled parking position of a designated vehicle when the luggage is delivered by a deliverer, and the designated vehicle being a delivery destination of the luggage;
determining, based on the first information acquired at the first timing, whether delivery of the luggage, by the deliverer, to the designated vehicle parked at the scheduled parking position when the deliverer delivers the luggage is possible;
acquiring, at a second timing, second information on position information of the designated vehicle, and the second timing being a predetermined timing after the first timing and before the luggage is delivered to the receiver;
determining, based on the second information acquired at the second timing, whether delivery of the luggage, by the deliverer, to the designated vehicle at a position indicated by the second information is possible;
transmitting predetermined first notification information to the receiver when the computer determines that delivery of the luggage to the designated vehicle is not possible; and
issuing authentication information for locking and unlocking the predetermined area of the designated vehicle to a terminal of the deliverer.
